(19) United States
(12) Patent Application Publication
(10) Pub. No.: US 2024/0348294 A1
(43) Pub. Date: Oct. 17, 2024

(54) CELLULAR NETWORK UPLINK ENHANCEMENT

(71) Applicant: AT&T Intellectual Property I, L.P., Atlanta, GA (US)

(72) Inventors: Yizhe Zhang, Austin, TX (US); Ratish Upadhyay, Frisco, TX (US)

(21) Appl. No.: 18/301,988

(22) Filed: Apr. 17, 2023

(51) Int. Cl. H04B 7/0413; H04B 17/336

(52) U.S. Cl. CPC H04B 7/0413; H04B 17/336

(57) ABSTRACT

A processing system including at least one processor of a base station of a cellular network may receive first uplink transmissions from a user equipment via multiple carriers in accordance with a carrier aggregation technique and may detect, for the first uplink transmissions, at least one of: a first signal to noise ratio for the user equipment exceeding a first signal to noise threshold or a first uplink throughput for the user equipment exceeding a first uplink throughput threshold. The processing system may next transmit a first instruction to the user equipment to switch from the carrier aggregation technique to a first uplink multiple input multiple output technique, in response to the detecting. The processing system may then receive second uplink transmissions from the user equipment in accordance with the first uplink multiple input multiple output technique.

The present disclosure relates generally to cellular networks, and more particularly to methods, non-transitory computer-readable media, and apparatuses for instructing a user equipment to switch from a carrier aggregation technique to a first uplink multiple input multiple output technique in response to detecting at least one of a first signal to noise ratio exceeding a first signal to noise threshold or a first uplink throughput exceeding a first uplink throughput threshold, and to methods, non-transitory computer-readable media, and apparatuses for instructing a user equipment to switch from a first uplink multiple input multiple output technique to a carrier aggregation technique in response to detecting at least one of a first signal to noise ratio falling below a first signal to noise threshold or a first uplink throughput falling below a first uplink throughput threshold.

### BACKGROUND

A cloud radio access network (RAN) is part of the 3^{rd} Generation Partnership Project (3GPP) fifth generation (5G) specifications for mobile networks. As part of the migration of cellular networks towards 5G, a cloud RAN may be coupled to an Evolved Packet Core (EPC) network until new cellular core networks are deployed in accordance with 5G specifications. For instance, a cellular network in a “non-stand alone” (NSA) mode architecture may include 5G radio access network components supported by a fourth generation (4G)/Long Term Evolution (LTE) core network (e.g., an EPC network). However, in a 5G “standalone” (SA) mode point-to-point or service-based architecture, components and functions of the EPC network may be replaced by a 5G core network.

### SUMMARY

In one example, the present disclosure discloses a method, computer-readable medium, and apparatus for instructing a user equipment to switch from a carrier aggregation technique to a first uplink multiple input multiple output technique in response to detecting at least one of a first signal to noise ratio exceeding a first signal to noise threshold or a first uplink throughput exceeding a first uplink throughput threshold. For example, a processing system including at least one processor of a base station of a cellular network may receive first uplink transmissions from a user equipment via multiple carriers in accordance with a carrier aggregation technique and may detect, for the first uplink transmissions, at least one of: a first signal to noise ratio for the user equipment exceeding a first signal to noise threshold or a first uplink throughput for the user equipment exceeding a first uplink throughput threshold. The processing system may next transmit a first instruction to the user equipment to switch from the carrier aggregation technique to a first uplink multiple input multiple output technique, in response to the detecting of the at least one of: the first signal to noise ratio for the user equipment exceeding the first signal to noise threshold or the first uplink throughput for the user equipment exceeding the first uplink throughput threshold. The processing system may then receive second uplink transmissions from the user equipment in accordance with the first uplink multiple input multiple output technique.

In one example, the present disclosure discloses a method, computer-readable medium, and apparatus for instructing a user equipment to switch from a first uplink multiple input multiple output technique to a carrier aggregation technique in response to detecting at least one of a first signal to noise ratio falling below a first signal to noise threshold or a first uplink throughput falling below a first uplink throughput threshold. For example, a processing system including at least one processor of a base station of a cellular network may receive first uplink transmissions from a user equipment in accordance with a first uplink multiple input multiple output technique and may detect, for the first uplink transmissions, at least one of: a first signal to noise ratio for the user equipment falling below a first signal to noise threshold or a first uplink throughput for the user equipment falling below a first uplink throughput threshold. The processing system may next transmit a first instruction to the user equipment to switch from the first uplink multiple input multiple output technique to a carrier aggregation technique, in response to the detecting of the at least one of: the first signal to noise ratio for the user equipment falling below the first signal to noise threshold or the first uplink throughput for the user equipment falling below the first uplink throughput threshold. The processing system may then receive second uplink transmissions from the user equipment in accordance with the carrier aggregation technique.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates a flowchart of an example process for switching between uplink transmission techniques, including uplink carrier aggregation and uplink multiple input multiple output techniques, in accordance with the present disclosure;

FIG. 3 illustrates a flowchart of an example method for instructing a user equipment to switch from a carrier aggregation technique to a first uplink multiple input multiple output technique in response to detecting at least one of a first signal to noise ratio exceeding a first signal to noise threshold or a first uplink throughput exceeding a first uplink throughput threshold;

FIG. 4 illustrates a flowchart of an example method for instructing a user equipment to switch from a first uplink multiple input multiple output technique to a carrier aggregation technique in response to detecting at least one of a first signal to noise ratio falling below a first signal to noise threshold or a first uplink throughput falling below a first uplink throughput threshold; and

FIG. 5 illustrates a high level block diagram of a computing device specifically programmed to perform the steps, functions, blocks and/or operations described herein.

To facilitate understanding, similar reference numerals have been used, where possible, to designate elements that are common to the figures.

### DETAILED DESCRIPTION

The present disclosure broadly discloses methods, non-transitory computer-readable media, and apparatuses for instructing a user equipment to switch from a carrier aggregation technique to a first uplink multiple input multiple output technique in response to detecting at least one of a first signal to noise ratio exceeding a first signal to noise threshold or a first uplink throughput exceeding a first uplink throughput threshold, and methods, non-transitory computer-readable media, and apparatuses for instructing a user equipment to switch from a first uplink multiple input multiple output technique to a carrier aggregation technique in response to detecting at least one of a first signal to noise ratio falling below a first signal to noise threshold or a first uplink throughput falling below a first uplink throughput threshold. In particular, examples of the present disclosure automatically and dynamically adjust between uplink multiple input-multiple output (MIMO) (including 2/4 layers) and uplink carrier aggregation techniques for user equipment (UE) served by a base station (e.g., a gNodeB, or gNB). In addition, examples of the present disclosure may further include power class and waveform switching to maximize UE throughput and coverage. To illustrate, in one example, the present disclosure may dynamically switch uplink layers when the signal to noise (SINR or SNR) exceeds a first threshold. For instance, when a SINR for a channel state information (CSI) reference signal (CSI-SINR) exceeds 15, the gNodeB may allocate and instruct a UE to utilize a 2/4 layer uplink MIMO technique. In addition, in one example, the UE may be instructed to use a cyclic prefix (CP) orthogonal frequency division multiplexing (OFDM) (CP-OFDM) waveform. Alternatively, or in addition, the UE may be instructed to utilize a power class 2 or 1.5 (e.g., for maximum transmit power (e.g., Pmax).

On the other hand, in one example, the present disclosure may automatically direct the UE to switch from uplink MIMO to an uplink carrier aggregation (CA) technique when the gNodeB detects the SINR falling below a second threshold (e.g., CSI-SINR below 7). In addition, in one example, the present disclosure may further monitor and detect when the SINR falls below a third threshold (e.g., CSI-SINR below 1). In such case, the gNB may automatically direct the UE to switch to a different waveform (e.g., a discrete Fourier transform (DFT)-spread OFDM (DFT-S-OFDM) waveform). In one example, the gNB may further instruct the UE to reduce a MCS (e.g., a “modulation coding scheme,” or “modulation and coding scheme”). For instance, this may include quadrature phase shift keying (QPSK), quadrature amplitude modulation (QAM), 16QAM, 64QAM, 256QAM, or the like. Thus, in accordance with the present disclosure, a gNodeB may actively monitor SINR and uplink throughput to make adjustments among MIMO uplink layers, to select between uplink MIMO (UL-MIMO) and uplink carrier aggregation (UL-CA), to direct waveform switching, MCS and/or modulation scheme adjustment, and so forth. It should also be noted that referred to herein, the term “signal to noise ratio” is intended to also include “” signal to interference and noise,” and vice versa. Thus, the acronyms SNR and SINR may similarly be used interchangeably.

Notably, the 5G new radio (NR) n77 band (e.g., 3300 to 4200 MHZ) is utilized in a time division duplexing (TDD) mode and may have higher propagation losses (e.g., compared to low- and mid-frequencies for frequency division duplexing (FDD)) due to the higher frequencies that are used. In addition, because of unbalanced downlink to uplink (DL:UL) ratio (e.g., 4:1), TDD uplink coverage may be approximately 7 dB worse than long term evolution (LTE) FDD at the same frequency. Thus, a base station using n77 TDD may have a limited footprint compared to FDD bands (e.g., at lower frequencies). It is further noted that augmented reality (AR), virtual reality (VR), and mixed reality (MR), and the like may seek to use up to 5 Mbps or more of uplink throughput. Emerging consumer applications and industry use cases may call for even higher uplink data throughput, e.g., up to 20 Mbps or more. As such, TDD uplink limitations may impact overall network coverage, as well as both uplink and downlink throughput. For instance, when downlink data throughput becomes extremely high, the uplink may be challenged by rapid and constant channel quality information (CQI) and ACK/NACK responses from UEs. At a minimum, it may be preferred that the uplink support 5 to 6 percent of the downlink data rate. Therefore, the uplink data rate can eventually limit the downlink data rate. In addition, coverage area and maximum downlink data rates may be limited by the uplink data rate performance in the absence of uplink enhancement in accordance with the present disclosure.

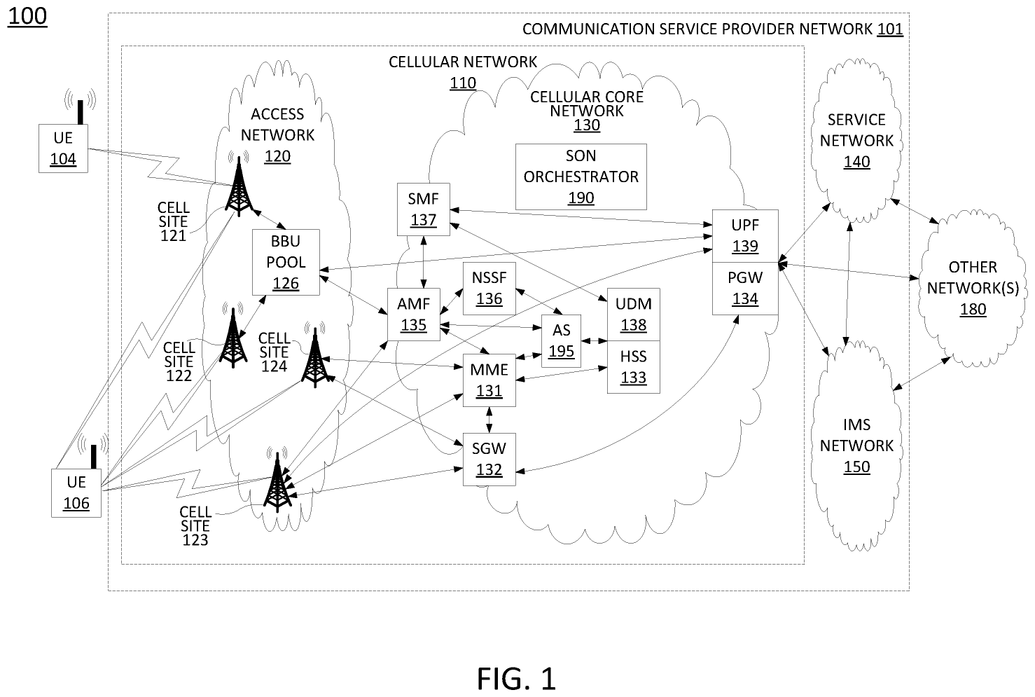

Thus, examples of the present disclosure provide a comprehensive system that dynamically monitors uplink SINR and/or uplink throughput, and that selects and assigns enhancement techniques to UEs, such as MIMO or CA, selections of waveform types, MCS and modulation scheme, and/or selections of transmit power levels. For instance, a gNodeB may monitor SINR and/or uplink throughput for a UE in real time. Once the UE achieves excellent signal level (e.g., SINR above 15, or the like), 2 or 4 uplink layer MIMO may be assigned to the UE. When SINR and/or uplink throughput deteriorates, the UE may be requested to adjust from 4 layer MIMO to 2 layer and then to switch from UL-MIMO to UL CA. When the signal level is even worse, the gNodeB may request the UE to switch waveform (e.g., from OFDM to DFT), to reduce MCS and/or adjust modulation, and so forth. Conversely, when the UE obtains improved signal levels, such as moving to a better signal area, the gNodeB may monitor and detect the situation, and may instruct the UE to change MCS and/or waveform, to switch from UL CA to UL-MIMO, to increase the number of MIMO layers, and/or to adjust other parameters accordingly. Thus, whenever the UE moves into a new area or otherwise experiences signal level change (such as moving from an outdoor to an indoor environment, parking garage, etc., or vice versa), the adjustment of the above configurations may be triggered by the gNodeB in order to optimize spectrum use, improve customer experience on throughput and battery consumption, and so forth. In one example, aspects of the present disclosure may be selectively applied to certain UEs, classes of UEs (e.g., UEs operating certain applications, such as augmented reality or virtual reality applications, video conferencing applications, etc.), and/or with respect to certain trigger conditions, such as for specific venues, special events, or the like. These and other aspects of the present disclosure are discussed in greater detail below in connection with the examples of FIGS. 1-5.

FIG. 1 illustrates an example network, or system 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU). In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU.

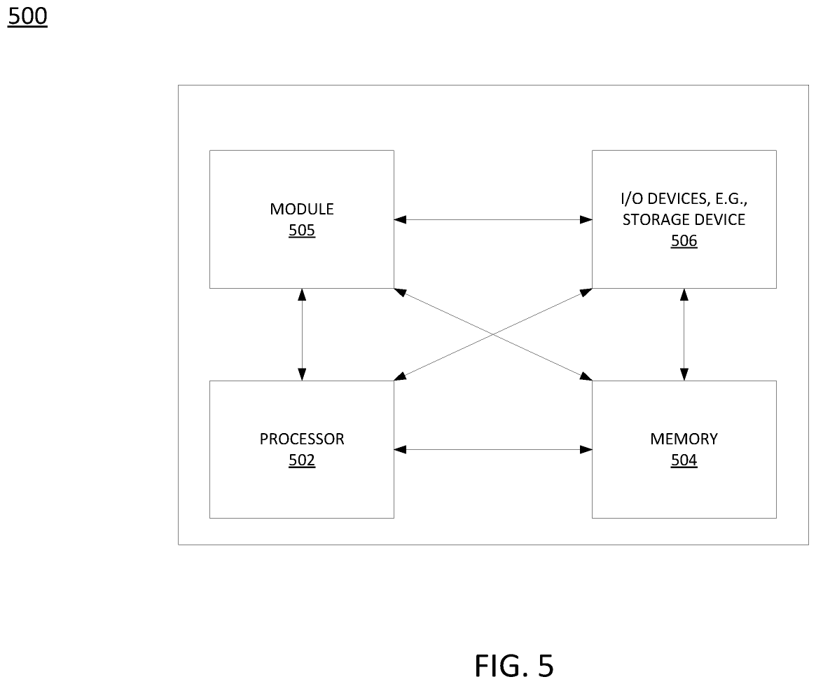

In accordance with the present disclosure, any one or more of cell sites 121-123 may be deployed with antenna and radio infrastructures, including multiple input multiple output (MIMO) and millimeter wave antennas. Furthermore, in accordance with the present disclosure, a base station (e.g., cell sites 121-123 and/or baseband units within BBU pool 126) may comprise all or a portion of a computing system, such as computing system 500 as depicted in FIG. 5, and may be configured to perform steps, functions, and/or operations in connection with examples of the present disclosure for instructing a user equipment to switch from a carrier aggregation technique to a first uplink multiple input multiple output technique in response to detecting at least one of a first signal to noise ratio exceeding a first signal to noise threshold or a first uplink throughput exceeding a first uplink throughput threshold and/or examples of the present disclosure for instructing a user equipment to switch from a first uplink multiple input multiple output technique to a carrier aggregation technique in response to detecting at least one of a first signal to noise ratio falling below a first signal to noise threshold or a first uplink throughput falling below a first uplink throughput threshold.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 5G network components, 3G network components, etc. Thus, cellular core network 130 may comprise an integrated network, e.g., including any two or more of 2G-5G infrastructures and technologies (or any future infrastructures and technologies to be deployed, e.g., 6G), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IOT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QOS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

In this regard, the cellular core network 130 may also include a self-optimizing network (SON) orchestrator 190 that may be responsible for activating and deactivating, allocating and deallocating, and otherwise managing a variety of network components. For instance, SON orchestrator 190 may activate and deactivate antennas/remote radio heads of cell sites 121 and 122, respectively, may steer antennas/remote radio heads of cell sites 121 and 122 (e.g., adjusting vertical tilt angles, azimuth bearings, beamwidths, power levels, and or other settings), may allocate or deallocate (or activate or deactivate) baseband units in BBU pool 126, may add (or remove) one or more network slices, and may perform other operations for adjusting configurations of components of cellular network 110. Accordingly, the SON orchestrator 190 may be connected directly or indirectly to any one or more network elements of cellular core network 130, and of the system 100 in general. Due to the relatively large number of connections available between SON orchestrator 190 and other network elements, none of the actual links to the SON orchestrator 190 are shown in FIG. 1. Similarly, intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., user equipment (UE) 104 and 106. UE 104 and 106 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). In one example, each of the UE 104 and UE 106 may each be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals. Each of the UE 104 and UE 106 may also include a gyroscope and compass to determine orientation(s), a global positioning system (GPS) receiver for determining a location (e.g., in latitude and longitude, or the like), and so forth. In one example, each of the UE 104 and UE 106 may also be configured to determine location/position from near field communication (NFC) technologies, such as Wi-Fi direct and/or other IEEE 802.11 communications or sensing (e.g., in relation to beacons or reference points in an environment), IEEE 802.15 based communications or sensing (e.g., “Bluetooth”, “ZigBee”, etc.), and so forth. In addition, in one example, each of the UE 104 and 106 may comprise all or a portion of a computing system, such as computing system 500 depicted in FIG. 5, and may be configured to perform steps, functions, and/or operations in connection with examples of the present disclosure for instructing a user equipment to switch from a carrier aggregation technique to a first uplink multiple input multiple output technique in response to detecting at least one of a first signal to noise ratio exceeding a first signal to noise threshold or a first uplink throughput exceeding a first uplink throughput threshold and/or examples of the present disclosure for instructing a user equipment to switch from a first uplink multiple input multiple output technique to a carrier aggregation technique in response to detecting at least one of a first signal to noise ratio falling below a first signal to noise threshold or a first uplink throughput falling below a first uplink throughput threshold.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

As illustrated in FIG. 1, UE 104 may access wireless services via the cell site 121 (e.g., NR alone, where cell site 121 comprises a gNB), while UE 106 may access wireless services via any of the cell sites 121-124 located in the access network 120 (e.g., for NR non-dual connectivity, for LTE non-dual connectivity, for NR-NR DC, for LTE-LTE DC, for EN-DC, and/or for NE-DC). For instance, in one example, UE 106 may establish and maintain connections to the cellular core network 130 via multiple gNBs (e.g., cell sites 121 and 122 and/or cell sites 121 and 122 in conjunction with BBU pool 126 and/or various other components, such as a CU and/or a DU). In another example, UE 106 may establish and maintain connections to the cellular core network 130 via a gNB (e.g., cell site 122 and/or cell site 122 in conjunction with BBU pool 126) and an eNodeB (e.g., cell site 124), respectively. In addition, either the gNB or the eNodeB may comprise a PCell, and the other may comprise a SCell for dual connectivity, as described herein. Similarly, UE 106 may communicate with any of the cell sites 121 and 122 using carrier aggregation (CA) (e.g., in accordance with a CA technique). Furthermore, either or both of NR/5G and or EPC (4G/LTE) core network components may manage the communications between UE 106 and the cellular network 110 via cell site 122 and cell site 124.

In one example, UE 106 may also utilize different antenna arrays for 4G/LTE and 5G/NR, respectively. For instance, 5G antenna arrays may be arranged for beamforming in a frequency band designated for 5G high data rate communications. For instance, the antenna array for 5G may be designed for operation in a frequency band greater than 5 GHZ. In one example, the array for 5G may be designed for operation in a frequency band greater than 20 GHz. In contrast, an antenna array for 4G may be designed for operation in a frequency band less than 5 GHZ, e.g., 500 MHz to 3 GHz. In addition, in one example, the 4G antenna array (and/or the RF or baseband processing components associated therewith) may not be configured for and/or be capable of beamforming. Accordingly, in one example, UE 106 may turn off a 4G/LTE radio, and may activate a 5G radio to send a request to activate a 5G session to cell site 122 (e.g., when it is chosen to operate in a non-DC mode or an intra-RAT dual connectivity mode), or may maintain both radios in an active state for multi-radio (MR) dual connectivity (MR-DC).

In various examples, UE 106 may measure and report to cell sites a signal to noise ratio (SNR, or SINR). For instance, UE 106 may receive a channel state information (CSI) reference signal from cell site 121, cell site 122, or the like. In addition, UE 106 may measure the SNR and may report the measurement to the cellular network 110 (e.g., reporting to the cell site that transmitted the reference signal, or to a different cell site). In one example UE 106 may alternatively or additionally measure and report throughput, e.g., on a dedicated or primary data radio bearer, on a secondary data radio bearer, etc. In one example, the UE 106 may transmit SINR and/or throughput measurements as messages via a DCCH logical channel over a signaling resource bearer (SRB), such as SRB 1 and/or SRB 3. For instance, the message(s) may be transmitted to one of the cell sites 121-124 to which the UE 106 maintains an RRC connected state. UE 106 may further receive and implement instructions from the cellular network 110 regarding whether to utilize carrier aggregation or MIMO, for MIMO, the number of layers to use, a transmission power level/class etc., whether to utilize an OFDM waveform or DFT waveform, a modulation coding scheme to utilize, and so forth.

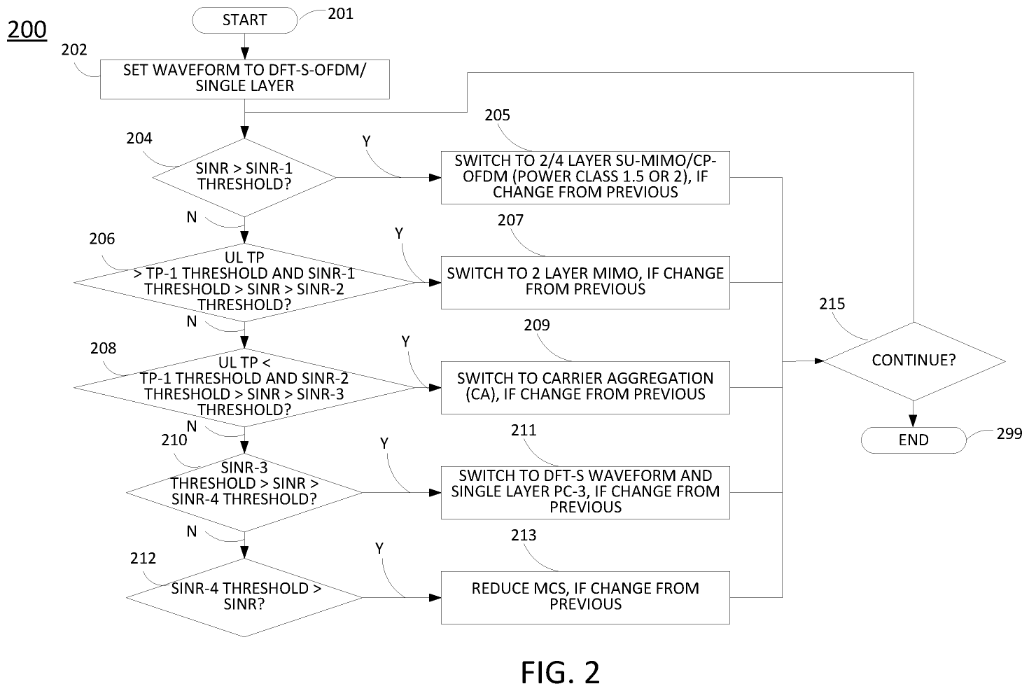

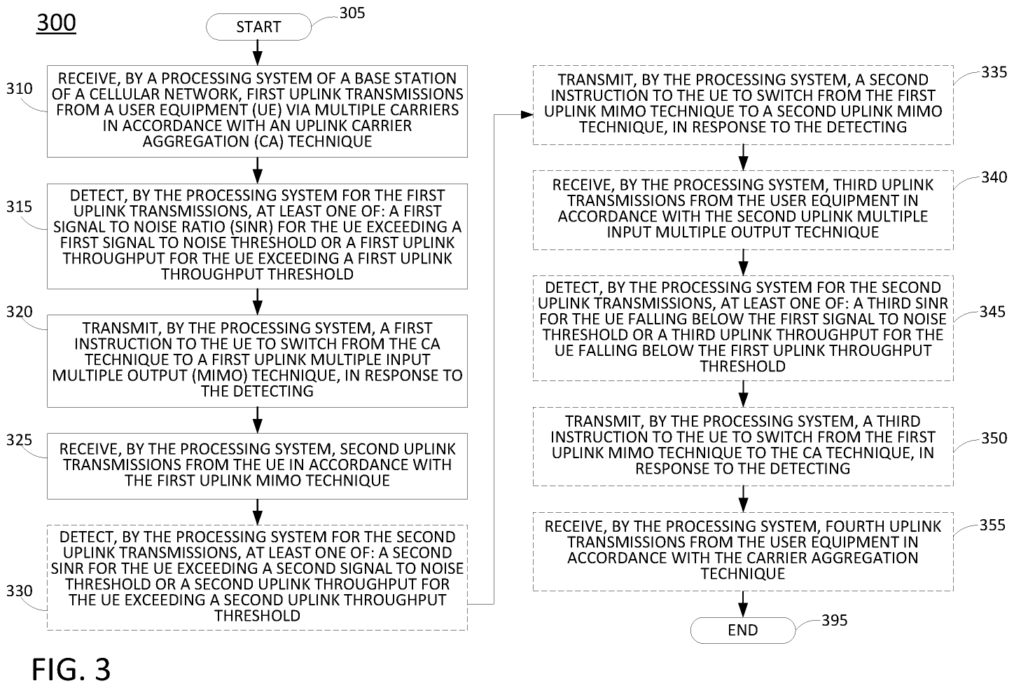

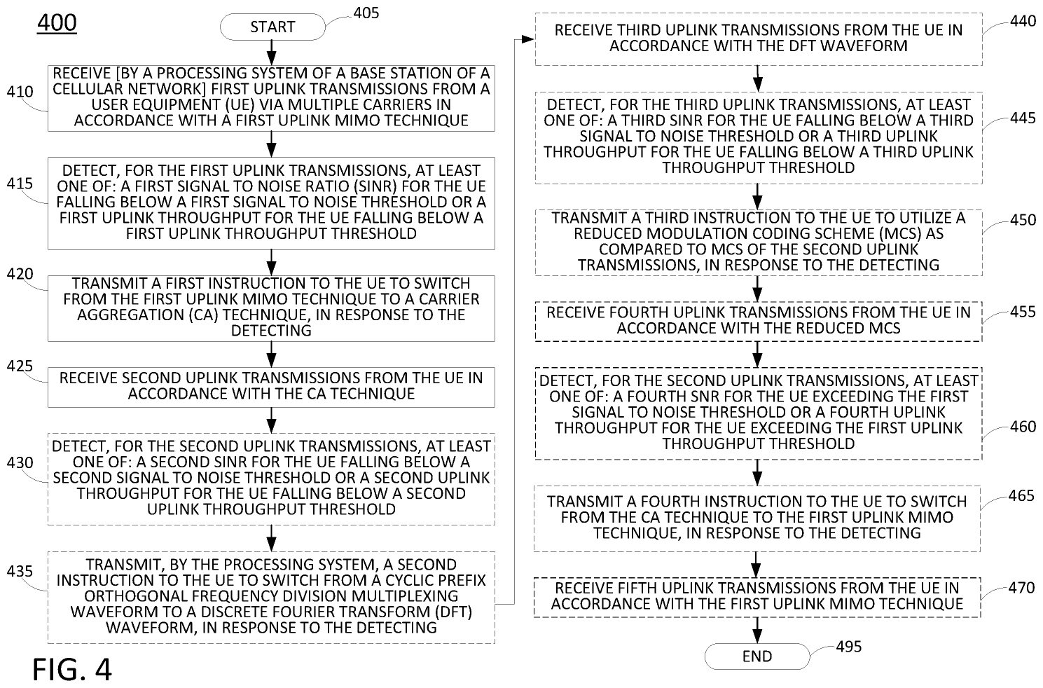

It should be noted that examples of the present disclosure as described herein primarily in connection with steps, functions, and/or operations that are performed by a base station (and/or any one or more components thereof). For instances, FIG. 2 illustrates an example process that may be performed by a base station in connection with establishing optimized uplink parameters for a UE. In addition, FIGS. 3 and 4 illustrate flowcharts of example methods that may be performed by a base station (and/or any one or more components thereof) for instructing a user equipment to switch from a carrier aggregation technique to a first uplink multiple input multiple output technique in response to detecting at least one of a first signal to noise ratio exceeding a first signal to noise threshold or a first uplink throughput exceeding a first uplink throughput threshold and for instructing a user equipment to switch from a first uplink multiple input multiple output technique to a carrier aggregation technique in response to detecting at least one of a first signal to noise ratio falling below a first signal to noise threshold or a first uplink throughput falling below a first uplink throughput threshold, respectively. However, in other, further, and different examples, various steps, functions, and/or operations as described in connection with FIGS. 2-4, or as described elsewhere herein, may alternatively or additionally be performed by one or more other components. For instance, various steps, functions, and/or operations may alternatively or additionally be performed by processing system in cellular core network 130, such as application server (AS) 195.

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of cell sites 121-123 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. Thus, these and other modifications are all contemplated within the scope of the present disclosure.

To aid in understanding the present disclosure, FIG. 2 illustrates a flowchart of an example process 200 for switching between uplink transmission techniques, including uplink carrier aggregation and uplink multiple input multiple output techniques, in accordance with the present disclosure. In one example, the process 200 may be performed by a processing system, e.g., of a cellular base station. The process 200 may begin in step 201 and proceed to step 202. In step 202, the processing system may assign to a user equipment an uplink transmission technique comprising a discrete Fourier transform spread (DFT-S) single layer orthogonal frequency division multiplexing (OFDM). In one example, the assigning may include instructing the UE to utilize the selected uplink transmission technique. At step 204, the processing system may determine whether a signal to noise ratio (SINR) exceeds a first threshold (SINR-1). In one example, the SINR may be obtained from the UE measuring a channel state information reference signal (CSI-RS). In another example, the SINR may be measured using a demodulation reference signal (DMRS) or a sounding reference signal (SRS) transmitted by the UE.

When the SINR exceeds the first threshold (SINR-1), the process 200 may proceed to step 205. In step 205, the processing system may assign to the UE an uplink transmission technique comprising a multi-layer (e.g., 2/4 layer) single user (SU) MIMO technique. In one example, the processing system may further assign to the UE a cyclic prefix (CP)-OFDM technique. Alternatively, or in addition, the processing system may assign to the UE a power class of 1.5 or 2. In one example, step 205 may comprise instructing the UE to utilize the selected uplink transmission technique(s) if the selected uplink transmission technique(s) is/are a change from the previous technique(s) assigned.

If the SINR does not exceed the first SINR threshold (SINR-1), the process 200 may proceed to step 206. In step 206, the processing system may determine whether an uplink (UL) throughput exceeds a first throughput threshold (TP-1) and whether the SINR is between the first SINR threshold (SINR-1) and a second SINR threshold (SINR-2). When it is determined that these conditions are satisfied, the process 200 may proceed to step 207. In step 207, the processing system may assign to the UE an uplink transmission technique comprising a two-layer MIMO technique. In one example, step 207 may comprise instructing the UE to utilize the selected uplink transmission technique(s) if the selected uplink transmission technique(s) is/are a change from the previous technique(s) assigned. On the other hand, if the conditions of step 206 are not satisfied, the process 200 may proceed to step 208.

In step 208, the processing system may determine whether an uplink (UL) throughput is below the first throughput threshold (TP-1) and whether the SINR is between the second SINR threshold (SINR-2) and a third SINR threshold (SINR-3). When it is determined that these conditions are satisfied, the process 200 may proceed to step 209. In step 209, the processing system may assign to the UE a carrier aggregation (CA) uplink transmission technique. In one example, step 209 may comprise instructing the UE to utilize the CA uplink transmission technique if CA would be a change from previous technique(s) assigned. On the other hand, if the conditions of step 208 are not satisfied, the process 200 may proceed to step 210.

In step 210, the processing system may determine whether the SINR is between the third SINR threshold (SINR-3) and a fourth SINR threshold (SINR-4). When it is determined that these conditions are satisfied, the process 200 may proceed to step 211. In step 211, the processing system may assign to the UE a single layer PC-3 (non-CA) uplink transmission technique. In one example, the processing system may further assign to the UE a DFT-S waveform for uplink transmission. In one example, step 211 may comprise instructing the UE to utilize the selected uplink transmission technique(s) if the selected uplink transmission technique(s) is/are a change from the previous technique(s) assigned. On the other hand, if the conditions of step 210 are not satisfied, the process 200 may proceed to step 212.

In step 212, the processing system may determine whether the SINR is below the fourth SINR threshold (SINR-4). When it is determined that this condition is satisfied, the process 200 may proceed to step 213. In step 213, the processing system may assign a reduced modulation coding scheme (MCS) to the UE (e.g., a reduction from 64 QAM to QAM), if the reduction would constitute a change from a previously assigned uplink transmission technique.

Following any of the steps 205, 207, 209, 211, or 213 the process 200 may proceed to step 215 where it may be determined whether the process 200 may continue. For instance, the process 200 may return to step 204 and continue to do so as long as the UE remains attached to the base station. Otherwise, the process 200 may proceed to step 299 where the process 200 may end.

It should be noted that the process 200 is just one illustrative example of a process for switching between uplink transmission techniques, in accordance with the present disclosure. Thus, it should be appreciated that in other, further, and different examples, the present disclosure may comprise processes in which the steps may be performed in a different order, steps may be omitted, combined, etc., new steps, such as intermediate steps, may be added, and so forth. As just one example, step 212 may be omitted. For instance, if the conditions of steps 204, 206, 208, and 210 are not satisfied, it may be assumed by default that the condition of step 212 is true (e.g., the SINR is below the fourth SINR threshold (SINR-4)). As such, if step 210 evaluates to “false,” the process 200 may proceed from step 210 to step 213. In one example, the present disclosure may incorporate a MCS switching algorithm that may determine whether and when to switch MCS based on various criteria beyond SINR or throughput. For instance, such an algorithm may be permitted to control when the SINR and/or throughput is below SINR-3 (e.g., steps 210-213). However, when above SINR-3, control may proceed in accordance with steps 202-208, etc.

In addition, although the foregoing describes conditions in which the SINR and/or throughput may exceed or fall below various thresholds, it should be understood that in various examples, the conditions may call for the respective metric to be “less than,” “less than or equal to,” “greater than” or “greater than or equal to” one or more of the respective thresholds. In this regard, it should also be understood that any specific values for the above-mentioned thresholds are illustrative in nature. Thus, for instance, the thresholds may be selected by a network operator based on operator preferences, time of day, day of week, etc. In one example, different cell sites, network sectors, etc. may have different thresholds for adjusting uplink transmission techniques. In one example, the processing system may utilize signal to noise ratios (e.g., SINRs) and may apply thresholds from two or more types of reference signals (e.g., either as individual thresholds and/or as one or more composite thresholds in accordance with a formula or weightings based on the constituent SINRs). For instance, a threshold at step 210 may be based on a combination of a CSI-RS SINR and a SNIR from a DMRS or SRS reference signal. In addition, with respect to a carrier aggregation technique, the SINR may be measured for a Pcell only, may be averaged over a Pcell and any Scells, and so forth. Thus, these and other modifications are all contemplated within the scope of the present disclosure.

FIG. 3 illustrates a flowchart of an example method 300 for instructing a user equipment to switch from a carrier aggregation technique to a first uplink multiple input multiple output technique in response to detecting at least one of a first signal to noise ratio exceeding a first signal to noise threshold or a first uplink throughput exceeding a first uplink throughput threshold, in accordance with the present disclosure. In one example, steps, functions and/or operations of the method 300 may be performed by a device as illustrated in FIG. 1, e.g., any of cell sites 121-124 and/or BBU pool 126 (e.g., including a CU and/or a DU, or the like), or any one or more components thereof, such as a processing system, or collectively via a plurality devices in FIG. 1, such as any one or more of cell sites 121-124 in conjunction with UE 106, AS 195, NSSF 136, AMF 135, and so forth. In one example, the steps, functions, or operations of method 300 may be performed by a computing device or system 500, and/or a processing system 502 as described in connection with FIG. 5 below. Similarly, in one example, the steps, functions, or operations of method 300 may be performed by a processing system comprising one or more computing devices collectively configured to perform various steps, functions, and/or operations of the method 300. For instance, multiple instances of the computing device or processing system 500 may collectively function as a processing system. For illustrative purposes, the method 300 is described in greater detail below in connection with an example performed by a processing system, such as processing system 502. The method 300 begins in step 305 and proceeds to step 310.

At step 310, the processing system (e.g., of a base station of a cellular network, or “cellular base station”) receives first uplink transmissions from a user equipment (UE) via multiple carriers in accordance with an uplink carrier aggregation (CA) technique. In one example, the base station operates in accordance with a time division duplexing (TDD) scheme for communication with endpoint devices/UEs. For instance, in one example, the base station may comprise a gNB or gNodeB. In one example, the processing system may comprise a baseband unit (BBU) (e.g., a CU and/or DU).

At step 315, the processing system detects, for the first uplink transmissions, at least one of: a first signal to noise ratio (SNR or SINR) for the UE exceeding a first signal to noise threshold or a first uplink throughput for the user equipment exceeding a first uplink throughput threshold. In one example, the SINR may be obtained from the UE measuring a channel state information reference signal (CSI-RS). In another example, the SINR may be measured using a demodulation reference signal (DMRS), a sounding reference signal (SRS), or the like that may be transmitted by the UE. Thus, in one example, the SINR may be an uplink SINR and the threshold may be an uplink SINR threshold.

At step 320, the processing system transmits a first instruction to the UE to switch from the CA technique to a first uplink multiple input multiple output (MIMO) technique, in response to the detecting of the at least one of: the first SNIR for the UE exceeding the first signal to noise threshold or the first uplink throughput for the UE exceeding the first uplink throughput threshold.

At step 325, the processing system receives second uplink transmissions from the UE in accordance with the first uplink MIMO technique.

At optional step 330, the processing system may detect, for the second uplink transmissions, at least one of: a second signal to noise ratio for the UE exceeding a second signal to noise threshold or a second uplink throughput for the UE exceeding a second uplink throughput threshold. For instance, the SINR and/or the uplink throughput may have increased (e.g., as compared to a SINR and/or uplink throughput detected at step 315). In other words, the second SINR threshold is greater than the first SINR threshold. To illustrate, in one example, the second SINR threshold may be “15” and the first SINR threshold may be “7.” Similarly, the second uplink throughput threshold is greater than the first uplink throughput threshold. To illustrate, in one example, the first uplink throughput threshold may be 2 Mbps and the second uplink throughput threshold may be 20 Mbps.

At optional step 335, the processing system may transmit a second instruction to the UE to switch from the first uplink MIMO technique to a second uplink MIMO technique, in response to the detecting of the at least one of: the second signal to noise ratio for the UE exceeding the second uplink signal to noise threshold or the second uplink throughput for the UE exceeding the second uplink throughput threshold. For instance, the first uplink MIMO technique may comprise a two layer uplink MIMO technique and the second uplink MIMO technique may comprise a four layer uplink MIMO technique. In one example, the second instruction may include an instruction to the UE to transmit with a power class of 1.5 or 2. In one example, the processing system may further assign to the UE a cyclic prefix (CP)-OFDM technique, or the like, via the second instruction.

At optional step 340, the processing system may receive third uplink transmissions from the user equipment in accordance with the second uplink multiple input multiple output technique. In one example, the third uplink transmissions may be in accordance with a power class of 1.5 or 2 (e.g., as may be indicated in the second instruction).

At optional step 345, the processing system may detect, for the second uplink transmissions a third signal to noise ratio for the UE falling below the first signal to noise threshold or a third uplink throughput for the UE falling below the first uplink throughput threshold.

At optional step 350, the processing system may transmit a third instruction to the UE to switch from the first uplink MIMO technique to the CA technique, in response to the detecting of the at least one of: the third signal to noise ratio for the UE falling below the first signal to noise threshold or the third uplink throughput for the UE falling below the first uplink throughput threshold.

At optional step 355, the processing system may receive fourth uplink transmissions from the UE in accordance with the CA technique. In this regard, it should be noted that although the terms, “first,” “second,” “third,” etc., may be used herein, the use of these terms are intended as labels only. Thus, the use of a term such as “third” in one example does not necessarily imply that the example must in every case include a “first” and/or a “second” of a similar item. In other words, the use of the terms “first,” “second,” “third,” and “fourth,” does not imply a particular number of those items corresponding to those numerical values. In addition, the use of the term “third” for example, does not imply a specific sequence, temporal relationship, or precedence with respect to a “first” and/or a “second” of a particular type of item, unless otherwise indicated.

Following step 325, optional step 340, or optional step 355, the method 300 may proceed to step 395 where the method 300 ends.

It should be noted that the method 300 may be expanded to include additional steps or may be modified to include additional operations or omit operations with respect to the steps outlined above. For example, the method 300 may be repeated through various cycles of SNIR and/or throughput changes as the UE remains attached to the base station (e.g., with changes in uplink transmission techniques according to one or more thresholds, and so forth). In one example, the processing system may detect that the SINR and/or uplink throughput exceeds a respective second threshold and may jump to the second uplink MIMO technique from the CA technique. In other words, steps 315 and 320 may be bypassed. Alternatively, optional steps 330-340 may precede steps 315-325. In one example, the method 300 may be expanded or modified to include steps, functions, and/or operations, or other features described in connection with the example(s) of FIGS. 1, 2, and/or 4, or as described elsewhere herein. For instance, as the SINR and/or throughput continues to deteriorate, the method 300 may further include the processing system detecting the SINR and/or throughput falling below one or more additional thresholds and the processing system instructing the UE to switch to a DFT-S waveform, to switch to a single layer (non-CA) uplink transmission technique, to reduce a modulation coding scheme, and so forth. For example, the method 300 may include additional steps relating to steps 210-213 of the process 200 of FIG. 2. Thus, these and other modifications are all contemplated within the scope of the present disclosure.

FIG. 4 illustrates a flowchart of an example method 400 for instructing a user equipment to switch from a first uplink multiple input multiple output technique to a carrier aggregation technique in response to detecting at least one of a first signal to noise ratio falling below a first signal to noise threshold or a first uplink throughput falling below a first uplink throughput threshold, in accordance with the present disclosure. In one example, steps, functions and/or operations of the method 400 may be performed by a device as illustrated in FIG. 1, e.g., any of cell sites 121-124 and/or BBU pool 126 (e.g., including a CU and/or a DU, or the like), or any one or more components thereof, such as a processing system, or collectively via a plurality devices in FIG. 1, such as any one or more of cell sites 121-124 in conjunction with UE 106, AS 195, NSSF 136, AMF 135, and so forth. In one example, the steps, functions, or operations of method 400 may be performed by a computing device or system 500, and/or a processing system 502 as described in connection with FIG. 5 below. Similarly, in one example, the steps, functions, or operations of method 400 may be performed by a processing system comprising one or more computing devices collectively configured to perform various steps, functions, and/or operations of the method 400. For instance, multiple instances of the computing device or processing system 500 may collectively function as a processing system. For illustrative purposes, the method 400 is described in greater detail below in connection with an example performed by a processing system, such as processing system 502. The method 400 begins in step 405 and proceeds to step 410.

At step 410, the processing system (e.g., of a base station of a cellular network, or “cellular base station”) receives first uplink transmissions from a user equipment (UE) in accordance with a first multiple input multiple output (MIMO) technique. In one example, the base station operates in accordance with a time division duplexing (TDD) scheme for communication with endpoint devices/UEs. For instance, in one example, the base station may comprise a gNB or gNodeB. In one example, the processing system may comprise a baseband unit (BBU) (e.g., a CU and/or DU).

At step 415, the processing system detects for the first uplink transmissions, at least one of: a first signal to noise ratio for the UE falling below a first signal to noise threshold or a first uplink throughput for the UE falling below a first uplink throughput threshold. In one example, the SINR may be obtained from the UE measuring a channel state information reference signal (CSI-RS). In another example, the SINR may be measured using a demodulation reference signal (DMRS), a sounding reference signal (SRS), or the like that may be transmitted by the UE. Thus, in one example, the SINR may be an uplink SINR and the threshold may be an uplink SINR threshold. To illustrate, the first SINR threshold may be “7” and/or the first uplink throughput threshold may be 2 Mbps. However, it should again be noted that various other threshold values may be set for the first SINR threshold and/or the first throughput threshold.

At step 420, the processing system transmits a first instruction to the UE to switch from the first uplink MIMO technique to a carrier aggregation (CA) technique, in response to the detecting of the at least one of: the first signal to noise ratio for the UE falling below the first signal to noise threshold or the first uplink throughput for the UE falling below the first uplink throughput threshold.

At step 425, the processing system receives second uplink transmissions from the UE in accordance with the CA technique.

At optional step 430, the processing system may detect, for the second uplink transmissions, at least one of: a second signal to noise ratio for the UE falling below a second signal to noise threshold (e.g., “1”) or a second uplink throughput for the UE falling below a second uplink throughput threshold (e.g., 500 Kbps). It should be noted that, in connection with the method 400, the second signal to noise threshold is less than the first signal to noise threshold. Similarly, the second uplink throughput threshold is less than the first uplink throughput threshold.

At optional step 435, the processing system may transmit a second instruction to the UE to switch from a cyclic prefix orthogonal frequency division multiplexing (CP-OFDM) waveform to a Discrete Fourier Transform (DFT) waveform, in response to the detecting of the at least one of: the second signal to noise ratio for the UE falling below the second signal to noise threshold or the second uplink throughput for the UE falling below the second uplink throughput threshold. For instance, the first uplink transmissions may be in accordance with the CP-OFDM waveform. However, with deteriorating uplink channel conditions, the UE may be transitioned to a DFT waveform.

At optional step 440, the processing system may receive third uplink transmissions from the UE in accordance with the Discrete Fourier Transform waveform.

At optional step 445, the processing system may detect, for the second uplink transmissions, at least one of: a third signal to noise ratio for the UE falling below a third signal to noise threshold (e.g., “0.5”) or a third uplink throughput for the UE falling below a third uplink throughput threshold (e.g., 200 Kbps).

At optional step 450, the processing system may transmit a third instruction to the UE to utilize a reduced modulation coding scheme (MCS) as compared to a modulation coding scheme of the second uplink transmissions, in response to the detecting of the at least one of: the third signal to noise ratio for the UE falling below the third uplink signal to noise threshold or the third uplink throughput for the UE falling below the third uplink throughput threshold. For instance, this may include transitioning to quadrature amplitude modulation (QAM), from a previous MCS of 16QAM, transitioning from 256 QAM to 64QAM or the like, and so on.

At optional step 455, the processing system may receive fourth uplink transmissions from the user equipment in accordance with the reduced modulation coding scheme.

At optional step 460, the processing system may detect, for the second uplink transmissions, at least one of: a fourth signal to noise ratio for the UE exceeding the first signal to noise threshold or a fourth uplink throughput for the UE exceeding the first uplink throughput threshold.

At optional step 465, the processing system may transmit a fourth instruction to the UE to switch from the CA technique to the first uplink MIMO technique, in response to the detecting of the at least one of: the fourth signal to noise ratio for the UE exceeding the first signal to noise threshold or the fourth uplink throughput for the UE exceeding the first uplink throughput threshold. In other words, optional steps 460 and 465 may relate to improving uplink channel conditions (after a prior deterioration detected at step 415 and corresponding change to the CA technique per steps 420 ad 425).

At optional step 470, the processing system may receive fifth uplink transmissions from the UE in accordance with the first uplink MIMO technique. For instance, optional steps 460-470 may comprise the same or similar operations as steps 315-325 of the method 300 of FIG. 3, as discussed above.

Following step 425, optional step 440, optional step 455, or optional step 470, the method 400 may proceed to step 495 where the method 400 ends.

It should be noted that the method 400 may be expanded to include additional steps or may be modified to include additional operations or omit operations with respect to the steps outlined above. For example, the method 400 may be repeated through various cycles of SNIR and/or throughput changes as the UE remains attached to the base station (e.g., with changes in uplink transmission techniques according to one or more thresholds, and so forth). In one example, following step 410 the processing system may detect that the SINR and/or uplink throughput has fallen below the second threshold and may jump to steps 430 and 435. In other words, steps 420 and 425 (or steps 415-425) may be bypassed. Alternatively, optional steps 430-440 may precede steps 420 and 425. In one example, the method 400 may be expanded or modified to include steps, functions, and/or operations, or other features described in connection with the example(s) of FIGS. 1-3, or as described elsewhere herein. For instance, as the SINR and/or throughput continues to improve (e.g., in accordance with steps 460-470), the method 400 may further include the processing system detecting the SINR and/or throughput exceeding one or more additional thresholds and the processing system further instructing the UE to switch to a CP-OFDM uplink transmission technique, and so forth. For example, the method 400 may include additional steps relating to steps 204 and 205 (or 204-207, etc.) of the process 200 of FIG. 2 and/or may similarly include additional steps relating to steps 330-335 of the method 300 of FIG. 3. Thus, these and other modifications are all contemplated within the scope of the present disclosure.

In addition, although not specifically specified, one or more steps, functions, or operations of the example method 300 or the example method 400 may include a storing, displaying, and/or outputting step as required for a particular application. In other words, any data, records, fields, and/or intermediate results discussed in the method(s) can be stored, displayed, and/or outputted either on the device executing the method or to another device, as required for a particular application. Furthermore, steps, blocks, functions or operations in FIGS. 3 and 4 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 5 depicts a high-level block diagram of a computing device or processing system specifically programmed to perform the functions described herein. For example, any one or more components or devices illustrated in FIG. 1, or described in connection with the example process 200 of FIG. 2 and/or the example methods 300 and 400 of FIGS. 3 and 4, respectively, may be implemented as the processing system 500. As depicted in FIG. 5, the processing system 500 comprises one or more hardware processor elements 502 (e.g., a microprocessor, a central processing unit (CPU) and the like), a memory 504, (e.g., random access memory (RAM), read only memory (ROM), a disk drive, an optical drive, a magnetic drive, and/or a Universal Serial Bus (USB) drive), a module 505 for instructing a user equipment to switch from a carrier aggregation technique to a first uplink multiple input multiple output technique in response to detecting at least one of a first signal to noise ratio exceeding a first signal to noise threshold or a first uplink throughput exceeding a first uplink throughput threshold, and/or for instructing a user equipment to switch from a first uplink multiple input multiple output technique to a carrier aggregation technique in response to detecting at least one of a first signal to noise ratio falling below a first signal to noise threshold or a first uplink throughput falling below a first uplink throughput threshold, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like). In accordance with the present disclosure input/output devices 506 may also include antenna elements, antenna arrays, remote radio heads (RRHs), baseband units (BBUs), transceivers, power units, and so forth.

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for instructing a user equipment to switch from a carrier aggregation technique to a first uplink multiple input multiple output technique in response to detecting at least one of a first signal to noise ratio exceeding a first signal to noise threshold or a first uplink throughput exceeding a first uplink throughput threshold, and/or for instructing a user equipment to switch from a first uplink multiple input multiple output technique to a carrier aggregation technique in response to detecting at least one of a first signal to noise ratio falling below a first signal to noise threshold or a first uplink throughput falling below a first uplink throughput threshold (e.g., a software program comprising computer-executable instructions) can be loaded into memory 504 and executed by hardware processor element 502 to implement the steps, functions or operations as discussed above in connection with the example method 300 or method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for instructing a user equipment to switch from a carrier aggregation technique to a first uplink multiple input multiple output technique in response to detecting at least one of a first signal to noise ratio exceeding a first signal to noise threshold or a first uplink throughput exceeding a first uplink throughput threshold, and/or for instructing a user equipment to switch from a first uplink multiple input multiple output technique to a carrier aggregation technique in response to detecting at least one of a first signal to noise ratio falling below a first signal to noise threshold or a first uplink throughput falling below a first uplink throughput threshold (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
receiving, by a processing system of a base station of a cellular network, first uplink transmissions from a user equipment via multiple carriers in accordance with a carrier aggregation technique;
detecting, by the processing system for the first uplink transmissions, at least one of: a first signal to noise ratio for the user equipment exceeding a first signal to noise threshold or a first uplink throughput for the user equipment exceeding a first uplink throughput threshold;
transmitting, by the processing system, a first instruction to the user equipment to switch from the carrier aggregation technique to a first uplink multiple input multiple output technique, in response to the detecting of the at least one of: the first signal to noise ratio for the user equipment exceeding the first signal to noise threshold or the first uplink throughput for the user equipment exceeding the first uplink throughput threshold; and
receiving, by the processing system, second uplink transmissions from the user equipment in accordance with the first uplink multiple input multiple output technique.

2. The method of claim 1, further comprising:
detecting, by the processing system for the second uplink transmissions, at least one of: a second signal to noise ratio for the user equipment exceeding a second signal to noise threshold or a second uplink throughput for the user equipment exceeding a second uplink throughput threshold;
transmitting, by the processing system, a second instruction to the user equipment to switch from the first uplink multiple input multiple output technique to a second uplink multiple input multiple output technique, in response to the detecting of the at least one of: the second signal to noise ratio for the user equipment exceeding the second signal to noise threshold or the second uplink throughput for the user equipment exceeding the second uplink throughput threshold; and
receiving, by the processing system, third uplink transmissions from the user equipment in accordance with the second uplink multiple input multiple output technique.

3. The method of claim 2, wherein the first uplink multiple input multiple output technique comprises a two layer uplink multiple input multiple output technique and wherein the second uplink multiple input multiple output technique comprises a four layer uplink multiple input multiple output technique.

4. The method of claim 2, wherein the second signal to noise threshold is greater than the first signal to noise threshold.

5. The method of claim 2, wherein the second uplink throughput threshold is greater than the first uplink throughput threshold.

6. The method of claim 2, wherein the second instruction includes an instruction to transmit with a power class of 1.5 or 2, wherein the third uplink transmissions are in accordance with the power class of 1.5 or 2.

7. The method of claim 1, further comprising:
detecting, by the processing system for the second uplink transmissions, at least one of: a third signal to noise ratio for the user equipment falling below the first signal to noise threshold or a third uplink throughput for the user equipment falling below the first uplink throughput threshold;
transmitting, by the processing system, a third instruction to the user equipment to switch from the first uplink multiple input multiple output technique to the carrier aggregation technique, in response to the detecting of the at least one of: the third signal to noise ratio for the user equipment falling below the first signal to noise threshold or the third uplink throughput for the user equipment falling below the first uplink throughput threshold; and
receiving, by the processing system, fourth uplink transmissions from the user equipment in accordance with the carrier aggregation technique.

8. The method of claim 1, wherein the base station operates in accordance with a time division duplexing scheme for communication with endpoint devices.

9. The method of claim 1, wherein the base station comprises a gNodeB.

10. A non-transitory computer-readable medium storing instructions which, when executed by a processing system including at least one processor of a base station of cellular network, cause the processing system to perform operations, the operations comprising:
receiving first uplink transmissions from a user equipment via multiple carriers in accordance with a carrier aggregation technique;
detecting, for the first uplink transmissions, at least one of: a first signal to noise ratio for the user equipment exceeding a first signal to noise threshold or a first uplink throughput for the user equipment exceeding a first uplink throughput threshold;
transmitting a first instruction to the user equipment to switch from the carrier aggregation technique to a first uplink multiple input multiple output technique, in response to the detecting of the at least one of: the first signal to noise ratio for the user equipment exceeding the first signal to noise threshold or the first uplink throughput for the user equipment exceeding the first uplink throughput threshold; and
receiving second uplink transmissions from the user equipment in accordance with the first uplink multiple input multiple output technique.

11. A method comprising:
receiving, by a processing system of a base station of a cellular network, first uplink transmissions from a user equipment in accordance with a first uplink multiple input multiple output technique;
detecting, by the processing system for the first uplink transmissions, at least one of: a first signal to noise ratio for the user equipment falling below a first signal to noise threshold or a first uplink throughput for the user equipment falling below a first uplink throughput threshold;
transmitting, by the processing system, a first instruction to the user equipment to switch from the first uplink multiple input multiple output technique to a carrier aggregation technique, in response to the detecting of the at least one of: the first signal to noise ratio for the user equipment falling below the first signal to noise threshold or the first uplink throughput for the user equipment falling below the first uplink throughput threshold; and
receiving, by the processing system, second uplink transmissions from the user equipment in accordance with the carrier aggregation technique.

12. The method of claim 11, further comprising:
detecting, by the processing system for the second uplink transmissions, at least one of: a second signal to noise ratio for the user equipment falling below a second signal to noise threshold or a second uplink throughput for the user equipment falling below a second uplink throughput threshold;
transmitting, by the processing system, a second instruction to the user equipment to switch from a cyclic prefix orthogonal frequency division multiplexing waveform to a discrete fourier transform waveform, in response to the detecting of the at least one of: the second signal to noise ratio for the user equipment falling below the second signal to noise threshold or the second uplink throughput for the user equipment failing below the second uplink throughput threshold; and
receiving, by the processing system, third uplink transmissions from the user equipment in accordance with the discrete fourier transform waveform.

13. The method of claim 12, wherein the first uplink transmissions are in accordance with the cyclic prefix orthogonal frequency division multiplexing waveform.

14. The method of claim 12, wherein the second uplink signal to noise threshold is less than the first uplink signal to noise threshold.

15. The method of claim 12, wherein the second uplink throughput threshold is less than the first uplink throughput threshold.

16. The method of claim 12, further comprising:
detecting, by the processing system for the third uplink transmissions, at least one of: a third signal to noise ratio for the user equipment falling below a third signal to noise threshold or a third uplink throughput for the user equipment falling below a third uplink throughput threshold;
transmitting, by the processing system, a third instruction to the user equipment to utilize a reduced modulation coding scheme as compared to a modulation coding scheme of the second uplink transmissions, in response to the detecting of the at least one of: the third signal to noise ratio for the user equipment falling below the third signal to noise threshold or the third uplink throughput for the user equipment failing below the third uplink throughput threshold; and
receiving, by the processing system, fourth uplink transmissions from the user equipment in accordance with the reduced modulation coding scheme.

17. The method of claim 11, further comprising:
detecting, by the processing system for the second uplink transmissions, at least one of: a fourth signal to noise ratio for the user equipment exceeding the first signal to noise threshold or a fourth uplink throughput for the user equipment exceeding the first uplink throughput threshold;
transmitting, by the processing system, a fourth instruction to the user equipment to switch from the carrier aggregation technique to the first uplink multiple input multiple output technique, in response to the detecting of the at least one of: the fourth signal to noise ratio for the user equipment exceeding the first signal to noise threshold or the fourth uplink throughput for the user equipment exceeding the first uplink throughput threshold; and
receiving, by the processing system, fifth uplink transmissions from the user equipment in-accordance with the first uplink multiple input multiple output technique.

18. The method of claim 17, wherein the first uplink multiple input multiple output technique comprises a two layer uplink multiple input multiple output technique and wherein the processing system and the UE are capable of communication via a second uplink multiple input multiple output technique, wherein the second multiple input multiple output technique comprises a four layer uplink multiple input multiple output technique.

19. The method of claim 11, wherein the base station operates in accordance with a time division duplexing scheme for communication with endpoint devices.

20. The method of claim 11, wherein the base station comprises a gNodeB.
